(19) United States
(12) Patent Application Publication
(10) Pub. No.: US 2007/0244722 A1
(43) Pub. Date: Oct. 18, 2007

(54) METHOD FOR DETERMINING REFRACTIVE STATE AND PROVIDING CORRECTIVE EYEWEAR

(76) Inventors: Gary Nathanael Wortz, Lexington, KY (US); William Wallaca Richardson, Lexington, KY (US)

Correspondence Address: KING & SCHICKLI, PLLC, 247 NORTH BROADWAY, LEXINGTON, KY, 40507, US

(21) Appl. No.: 11/734,569

(22) Filed: Apr. 12, 2007

Related U.S. Application Data
(60) Provisional application No. 60/791,573, filed on Apr. 12, 2006.

(51) Int. Cl. G06Q 10/00

(52) U.S. Cl. 705/2

(57) ABSTRACT

A method is described for a consumer driven business practice that allows the consumer easy access to refractive spectacles without the need for an initial professional evaluation, thereby reducing the barriers implicit to the current process of obtaining such devices. The method may also serve the purpose of providing a general vision screening which would benefit public health. A professional evaluation may be provided after the manufacturing and distribution of the refractive spectacles or in the event of a failed vision screening.

This application claims the benefit of Provisional Patent Application Ser. No. 60/791,573, filed Apr. 12, 2006.

### TECHNICAL FIELD

The present invention relates to prescription eyewear and, more particularly, to a method and related apparatus for dispensing the prescription eyewear.

### BACKGROUND OF THE INVENTION

In the current practice of dispensing prescription eyewear or spectacles, a consumer is faced with a number of challenges that make access to these medical devices challenging. First, the consumer must find an ophthalmologist or optometrist for an eye exam. At this point, the consumer will be made aware of any refractive error, his or her baseline visual acuity without spectacle correction and the consumer's best corrected visual acuity. Should the consumer be interested in purchasing spectacles, the ophthalmologist or optometrist must furnish the consumer with a prescription.

At that point, the consumer can take this prescription to any business that sells prescription eyeglasses. This could be an internet spectacle dispensary or a local optical shop. The physical parameters of the consumer's face are measured, and various eyeglasses are tried on for fit and stylistic considerations. After the frames are selected, the lenses are ground to the specifications of the prescription, with various other options such as tint, polarization, and anti-glare coatings added according to the consumer's preference.

Efforts in the last decade have been made to streamline this process. Most notably, businesses such as Lenscrafters, Inc. have made promises of distributing glasses from start to finish in about 1 hour. With in house optometrists and an on-site optical shop, the consumer has a one stop store that allows them better access to eyeglasses. However, this still has left people in more rural areas and developing countries without a local optometrist or optical shop without access to these necessary devices. Accordingly, a need exists for a new method and system for prescribing lenses and providing spectacles without the aid or assistance of a licensed ophthalmologis or optometrist prior to provision of the spectacles. Ideally, the spectacles would be verified by such a professional for fit, function, and structural integrity after delivery but this assistance is not always readily available particularly in developing countries.

### SUMMARY OF THE INVENTION

In accordance with one aspect of the present invention, a method of providing spectacles for a consumer without requiring professional judgment prior to issuance of the spectacles is disclosed. The method comprises deriving the consumer's glasses refraction, measuring at least one anatomical structure of the consumer required to provide suitable spectacles, and providing spectacles based at least in part on the derived glasses refraction and measured anatomical structure. Preferably, the consumer's glasses refraction is derived using a subjective automated refractometer.

In accordance with another aspect of the present invention, the method further comprises displaying at least one spectacle frame for selection by the consumer, and the step of providing spectacles is further based on the selection by the consumer.

In yet another aspect of the present invention, the method further comprises capturing an image of the consumer, and the displaying step is based at least in part on the measured anatomical structure. Alternatively or in addition, the displaying step may be based at least in part on the derived consumer's glasses refraction.

In still another aspect of the present invention, the method further comprises displaying at least one spectacle frame for selection by the consumer, and the step of providing spectacles is further based on the selection by the consumer.

In accordance with another important aspect of the present invention, an apparatus for providing spectacles for a consumer without requiring professional judgment prior to issuance of the spectacles is disclosed. The apparatus comprises means for deriving the consumer's glasses refraction, means for measuring at least one anatomical structure of the consumer required to provide suitable spectacles, and means for providing spectacles based at least in part on the derived glasses refraction and measured anatomical structure,

In one embodiment, the means for deriving the consumer's gasses refraction comprises an automated refractometer. In this or yet another embodiment, the automated refractometer is a subjective refractometer capable of calculating an interpupillary distance. In yet another or one of the above embodiments, the means for measuring at least one anatomical structure of the consumer comprises a calibrated real-time video measuring device.

In accordance with still another important aspect of the present invention, an apparatus for providing spectacles for a consumer without requiring professional judgment prior to issuance of the spectacles is disclosed. The apparatus comprises a subjective refractometer for deriving the consumer's glasses refraction, a real-time video measuring device for measuring at least one anatomical structure of the consumer required to provide suitable spectacles, a display for displaying at least one pair of spectacle frames based at least in part on the derived glasses refraction and measured anatomical structure, and an input device for receiving consumer feedback during at least one of the derivation of the consumer's glasses refraction and the selection of the displayed spectacle frames. In one embodiment, the input device is further capable of receiving alphanumeric data representing information about the consumer including possibly a spectacle prescription.

In accordance with yet another aspect of the present invention, the apparatus may further comprise a dispenser for distributing routine eye health education information.

### BRIEF DESCRIPTION OF THE DRAWINGS

The accompanying drawing incorporated in and forming a part of this specification, illustrates several aspects of the present invention, and together with the description serve to explain certain principles of the invention. In the drawings:

FIG. 1 is a block schematic diagram showing the components of the kiosk system.

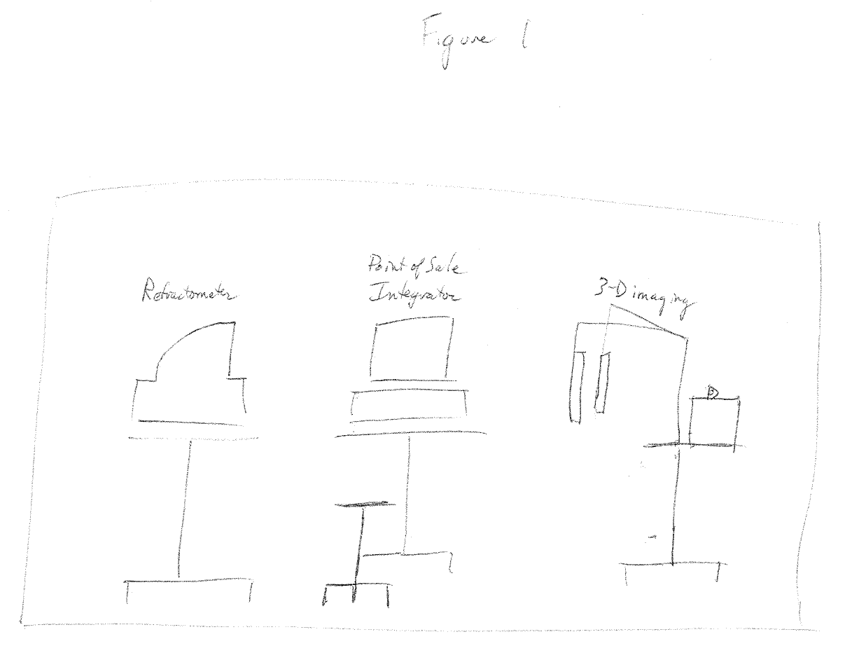

Reference will now be made in detail to the present preferred embodiments of the invention, examples of which are illustrated in the accompanying drawing figures.

### DETAILED DESCRIPTION OF THE PREFERRED EMBODIMENTS OF THE TNVENTION

With the advent of recent technological advances, a new business model has been developed for the prescribing of lenses, to the final distribution of a completed pair of spectacles or eyeglasses. In the past, a licensed ophthalmologist or optometrist was required to perform a subjective refraction based on giving a consumer a choice between lenses. The response of the consumer would allow the refractionist to alter the lens prescription until it achieved the best possible result.

A new device, called a subjective auto-refractor, has been developed and is now commercially available. One such device is the Topcon BV-1000. This device is based on intelligent software, which integrates voice prompts to guide a consumer through this same refracting process. The consumer uses buttons to enter his or her choice, and the appropriate change is made to the lens that the consumer is looking through. This process goes on until the best spectacle correction has been achieved, and a prescription is then recorded for the consumer.

Another recent technological advance has been made in the field of spectacle dispensing. There are now in the marketplace a number of products that allow consumers to try on spectacle frames “virtually” through computer modeling. One of these products, the Visionix eDiView, takes a 3-dimensional image of a consumer's face. Then the consumer is able to virtually try on frames stored a in a 3-dimensional database, which have also been modeled 3-dimensionally. This machine also very accurately measures anatomical structures that are vital to ensuring that the spectacles will fit correctly, and prevents the consumer from being unhappy with the final product. In addition, this particular company allows the consumer to log in to a web-based server to virtually try on frames from the comfort of his or her home.

In addition to the previous advances, there are now multiple online optical dispensaries which will make any glasses according to the consumers specifications, and ship the completed spectacles directly to the consumer. One of these online dispensaries is www.optical4less.com. This company will partner with local eyecare professionals to supply completed spectacles.

Using these technologies, the present preferred embodiment of the invention comprises a self-service kiosk type spectacle or eyeglasses dispensary which does not require the presence of an ophthalmologist or optometrist. The preferred embodiment of this invention would have a subjective auto-refractor, such as a Topeon BV-1000 for example, a virtual “try-on” machine, such as a Visionix 3DiView for example, and a related method for choosing and purchasing prescription spectacles.

Even more, the present invention could be monitored by an attendant employed to assist with technical difficulties and with monetary transactions, as well as general overseeing of the equipment and process. In general, a consumer would be charged for a subjective auto-refraction. He or she would then be told his or her vision without spectacles and with best correction. At this point, the consumer would be given the option of purchasing spectacles through the virtual try on system and integrated online optical dispensary, if desired.

The consumer's image would be taken and then they would be able to “virtually” try on spectacles via a computer-based system. The consumer would either be able to purchase the glasses directly at that time, or be able to log in to a secure website and purchase spectacles at a later date through the website system. The data would be saved which would allow the consumer to buy future pairs of spectacles with the same prescription, and using the same image of his or her face. Preferably, the consumer would be offered a full eye exam, which he or she could choose at a later date to keep or not to keep. In the present preferred embodiment, each place of business would have a local affiliated ophthalmologist or optometrist to perform this function, in an ex post facto manner. As indicated above, however, the availability of such professionals varies dependent upon the location of the consumer and may not be available in developing countries, for example.

In accordance with the present invention, the consumer would be given a certain period of time to which they could return the spectacles if they were unhappy. Consumers who were unable to achieve acceptable vision levels with best spectacle correction would be referred to the affiliated eyecare professional for a full evaluation. This place of business could also function as an advertising tool for the affiliated optometrist or ophthalmologist, showcasing what services he or she provides. It would also function for public health benefit, as it could provide low cost basic vision screening, and have multi-media information regarding eye health and general eye problems.

The present invention could also be used in remote locations of the world as a simple means of prescribing lenses and distributing a completed pair of spectacles or eyeglasses.

The foregoing description of the preferred embodiments of the present invention have been presented for purposes of illustration and description. It is not intended to be exhaustive or to limit the invention to the precise form disclosed. Obvious modifications or variations are possible in light of the above teachings. The embodiments were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled. The drawings and preferred embodiments do not and are not intended to limit the ordinary meaning of the claims in their fair and broad interpretation in any way.

1. A method of providing spectacles for a consumer without requiring professional judgment prior to issuance of the spectacles, comprising:
deriving the consumer's glasses refraction;
measuring at least one anatomical structure of the consumer required to provide suitable spectacles; and
providing spectacles based at least in part on the derived glasses refraction and measured anatomical structure.

2. The method of claim 1 wherein the consumer's glasses refraction is derived using a subjective automated refractometer.

3. The method of claim 2 further comprising the step of displaying at least one spectacle frame for selection by the consumer, and
wherein the step of providing spectacles is further based on the selection by the consumer.

4. The method of claim 3, further comprising the step of capturing an image of the consumer, and wherein the displaying step is based at least in part on the measured anatomical structure.

5. The method of claim 3 wherein the displaying step is based at least in part on the derived consumer's glasses refraction.

6. The method of claim 1 wherein the deriving step comprises calculating an interpupillary distance.

7. The method of claim 1 wherein the at least one anatomical structure of the consumer is measured using a calibrated real-time video measuring device.

8. The method of claim 1 further comprising the step of displaying at least one spectacle frame for selection by the consumer, and
wherein the step of providing spectacles is further based on the selection by the consumer.

9. The method of claim 8, wherein the displaying step is based at least in part on the measured anatomical structure.

10. The method of claim 8 wherein the displaying step is based at least in part on the derived consumer's glasses refraction.

11. The method of claim 8 wherein the deriving step comprises calculating an interpupillary distance.

12. The method of claim 8 wherein the at least one anatomical structure of the consumer is measured using a calibrated real-time video measuring device.

13. An apparatus for providing spectacles for a consumer without requiring professional judgment prior to issuance of the spectacles, comprising:
means for deriving the consumer's glasses refraction;
means for measuring at least one anatomical structure of the consumer required to provide suitable spectacles; and
means for providing spectacles based at least in part on the derived glasses refraction and measured anatomical structure.

14. The apparatus of claim 13, wherein the means for deriving the consumer's gasses refraction comprises an automated refractometer.

15. The apparatus of claim 14, wherein the automated refractometer is a subjective refractometer capable of calculating an interpupillary distance.

16. The apparatus of claim 14, wherein the means for measuring at least one anatomical structure of the consumer comprises a calibrated real-time video measuring device.

17. An apparatus for providing spectacles for a consumer without requiring professional judgment prior to issuance of the spectacles, comprising:
a subjective refractometer for deriving the consumer's glasses refraction;
a real-time video measuring device for measuring at least one anatomical structure of the consumer required to provide suitable spectacles;
a display for displaying at least one pair of spectacle frames based at least in part on the derived glasses refraction and measured anatomical structure; and
an input device for receiving consumer feedback during at least one of the derivation of the consumer's glasses refraction and the selection of the displayed spectacle frames.

18. The apparatus of claim 17, wherein the input device is further capable of receiving alphanumeric data representing information about the consumer.

19. The apparatus of claim 18, wherein the alphanumeric data represents a spectacle prescription.

20. The apparatus of claim 17, further comprising a dispenser for distributing routine eye health education information.
